(19) United States
(12) Patent Application Publication
(10) Pub. No.: US 2018/0134610 A1
(43) Pub. Date: May 17, 2018

(54) GLASS FOR CHEMICAL STRENGTHENING AND CHEMICALLY STRENGTHENED GLASS

(71) Applicant: ASAHI GLASS COMPANY, LIMITED, Chiyoda-ku (JP)

(72) Inventors: Yuichi YAMAMOTO, Tokyo (JP); Kosho AKATSUKA, Tokyo (JP); Hideharu TORll, Tokyo (JP)

(73) Assignee: ASAHI GLASS COMPANY, LIMITED, Chiyoda-ku (JP)

(21) Appl. No.: 15/808,978

(22) Filed: Nov. 10, 2017

(30) Foreign Application Priority Data
Nov. 16, 2016 (JP) 2016-223041
Sep. 29, 2017 (JP) 2017-190684

(51) Int. Cl. C03C 3/087; C03C 21/00; C03C 3/085; C03C 4/18

(52) U.S. Cl. CPC C03C 3/087; C03C 21/002; C03C 2204/00; C03C 4/18; C03C 3/085

(57) ABSTRACT

A glass for chemical strengthening contains, in terms of mol percentage based on oxides, SiO₂: 60 to 67%, Al₂O₃: 9 to 13.5%, Na₂O: 13.5 to 18.5%, K₂O: 0.1 to 3%, MgO: 6 to 10.5%, and TiO₂: more than 0% and 5% or less. The glass has a main surface and a back surface opposing the main surface. A tin content in the back surface is larger than a tin content in the main surface. A hydrogen concentration in a depth of 1 to 2 μm in a sheet thickness direction from a surface of the main surface is gradually decreased in a depth direction.

### TECHNICAL FIELD

The present invention relates to a glass for chemical strengthening and a glass chemically strengthened (hereinafter also referred to as a chemically strengthened glass).

### BACKGROUND ART

In recent years, in flat display panel devices (hereinafter referred to as devices) such as mobile phones or personal digital assistants (PDA), a chemically strengthened glass is used as a cover glass. The chemically strengthened glass is required to have strength such that it does not break in a case where it is mounted on devices and the devices have been dropped.

An index showing strength of a chemically strengthened glass includes a compressive stress value (CS value). A glass for chemical strengthening is required that a chemically strengthened glass having high CS value (for example, 1000 MPa or more) is obtained through one chemical strengthening treatment. On the other hand, the chemically strengthened glass improves hand feeling by chamfering an edge portion of an end face when mounted on devices.

Patent Document 1 discloses obtaining a chemically strengthened glass having CS value exceeding 1000 MPa by applying chemical strengthening treatment twice to a glass for chemical strengthening. Patent Document 2 discloses that H concentration distribution of a glass affects warp of a chemically strengthened glass.

### PRIOR ART DOCUMENTS

### Patent Documents

Patent Document 1: WO2012/043482

Patent Document 2: WO2013/005588

### SUMMARY OF THE INVENTION

### Problems that the Invention is to Solve

However, none of the above documents disclose and suggest a glass for chemical strengthening that can obtain a chemically strengthened glass having high CS value through one chemical strengthening treatment and can suppress defects of an edge portion when chamfering the chemically strengthened glass.

An object of the present invention is to provide a glass for chemical strengthening that can obtain a chemically strengthened glass having high CS value through one chemical strengthening treatment and can suppress defects of an edge portion when chamfering the chemically strengthened glass.

### Means for Solving the Problems

The present inventors have found that the above problems can be solved by a glass for chemical strengthening having a specific glass composition, in which a hydrogen concentration in a depth of 1 to 2 μm in a sheet thickness direction from the surface of the main surface thereof is gradually decreased in a depth direction, and have completed the present invention.

The present invention relates to the following <1> to <8>.

<1> A glass for chemical strengthening containing, in terms of mol percentage based on oxides:

SiO₂: 60 to 67%,

Al₂O₃: 9 to 13.5%,

Na₂O: 13.5 to 18.5%,

K₂O: 0.1 to 3%,

MgO: 6 to 10.5%, and

TiO₂: more than 0% and 5% or less,

in which the glass has a main surface and a back surface opposing the main surface, a tin content in the back surface is larger than a tin content in the main surface, and a hydrogen concentration in a depth of 1 to 2 μm in a sheet thickness direction from a surface of the main surface is gradually decreased in a depth direction.

<2> The glass for chemical strengthening according to <1>, in which a hydrogen concentration in a depth of 1 to 2 μm in a sheet thickness direction from a surface of the back surface is gradually decreased in a depth direction.
<3> The glass for chemical strengthening according to <1>, in which a hydrogen concentration in a depth of 1 to 10 μm in a sheet thickness direction from the surface of the main surface is lower than a hydrogen concentration in a depth of 1 to 10 μm in a sheet thickness direction from a surface of the back surface.
<4> The glass for chemical strengthening according to any one of <1> to <3>, in which a temperature T4 at which a viscosity of the glass reaches 10⁴ dPa·s is 1255° C. or lower.
<5> The glass for chemical strengthening according to any one of <1> to <4>, further containing ZrO₂ in an amount of more than 0.11% and 4.0% or less in terms of mol percentage based on oxide.
<6> A chemically strengthened glass obtained by chemically strengthening the glass for chemical strengthening according to any one of <1> to <5>.
<7> The chemically strengthened glass according to <6>, having a surface compressive stress (CS) of 900 MPa or more.
<8> The chemically strengthened glass according to <6> or <7>, having a depth of a compressive stress layer (DOL) of 30 μm or more.

### Advantageous Effects of the Invention

The glass for chemical strengthening of the present invention is a glass that can obtain a glass chemically strengthened having high CS value through one chemical strengthening treatment, and can suppress defects of an edge portion when chamfering the chemically strengthened glass.

### BRIEF DESCRIPTION OF THE DRAWING

FIG. 1 is a view showing profiles of a hydrogen concentration on a top surface (main surface) and a bottom surface (back surface) of an Invention Product and a Conventional Product. The vertical axis shows a hydrogen concentration (atoms/cm³), and the horizontal axis shows a depth (μm) in a sheet thickness direction from the surface.

### MODE FOR CARRYING OUT THE INVENTION

The present invention is described in detail below. However, the present invention is not limited to the following embodiments, and can be carried out by optionally modifying within the scope that does not depart the gist of the present invention. In the present description, in the case of simply describing “%”, it means “mol %”, and the range “ . . . to . . . ” means equal to or more than the lower limit value and equal to or less than the upper limit value.

### <Glass for Chemical Strengthening>

The glass for chemical strengthening according to the present invention (hereinafter sometimes referred to as a “glass” for simplicity) contains, in terms of mol percentage based on oxides, SiO₂: 60 to 67%, Al₂O₃: 9 to 13.5%, Na₂O: 13.5 to 18.5%, K₂O: 0.1 to 3%, MgO: 6 to 10.5%, and TiO₂: more than 0% and 5% or less.

Each component in the glass composition is described below.

SiO₂ is a major component constituting a glass. Furthermore, it is a component reducing generation of cracks when scratches (indentations) have been formed on a glass surface or decreasing a rate of fracture when indentations have formed after chemical strengthening. Furthermore, SiO₂ is also a component enhancing acid resistance of a glass and decreasing an amount of sludge (enhancing hydrofluoric acid resistance) when conducting an etching treatment.

On the other hand, when the content of SiO₂ is too large, a viscosity at high temperature becomes too high, leading to the deterioration of productivity. For this reason, the content of SiO₂ is 60 to 67%. It is preferably 62% or more, and more preferably 63% or more, and is preferably 66% or less, and more preferably 65% or less.

Al₂O₃ can increase CS when conducting a chemical strengthening treatment as the amount thereof is large, but DOL is decreased. For this reason, the content of Al₂O₃ is 9 to 13.5%. It is preferably 9.5% or more, and more preferably 10% or more, and is preferably 12% or less, and more preferably 11.5% or less.

Na₂O is an essential component forming a surface compressive stress layer by ion exchange, and has an action to increase DOL. Furthermore, it is a component decreasing a melting temperature and a devitrification temperature of a glass and enhancing meltability and formability of a glass. Na₂O is a component increasing non-bridging oxygen, and in a case where the content of Na₂O is large, variation of chemical strengthening properties when a water content in a glass has varied is decreased.

Na₂O increases DOL when conducting a chemical strengthening treatment as the amount thereof is large, but CS is sometimes decreased. Furthermore, when Na₂O is contained, DUV resistance tends to be decreased. Therefore, less non-bridging oxygen is preferred from the standpoint of DUV resistance.

The DUV resistance is a property preventing deterioration of a transmittance in a specific wavelength region to ultraviolet rays in a short wavelength region called Deep UV (DUV).

For this reason, the content of Na₂O is 13.5 to 18.5%. It is preferably 14.5% or more, and more preferably 15% or more, and is preferably 17.5% or less, and more preferably 16.5% of less.

K₂O has the effects of increasing an ion exchange rate to increase DOL and decreasing a melting temperature of a glass, and is a component increasing non-bridging oxygen. Furthermore, it can avoid the increase of change of surface compressive stress by NaNO₃ concentration in a potassium nitrate molten salt used in a chemical strengthening treatment. Additionally, a small amount of K₂O has the effect of suppressing the intrusion amount of tin from a bottom surface when forming a glass sheet by a float process. Therefore, it is preferred to be contained when conducting forming by a float process. To exhibit the above effects, the content of K₂O in the glass of the present invention is 0.1% or more, preferably 0.3% or more, and more preferably 0.4% or more.

On the other hand, when the content of K₂O is too large, CS is decreased. Furthermore, when K₂O is contained, DUV resistance tends to be deteriorated. From those standpoints, the content of K₂O is 3% or less, preferably 2% or less, more preferably 1.3% or less, still more preferably 1% or less, and still further preferably 0.95% or less.

MgO is a component of stabilizing a glass and enhancing meltability, and when this is added, the content of an alkali metal is decreased, and the increase of a coefficient of thermal expansion (CTE) can be suppressed. To exhibit the above effects, the content of MgO in the glass of the present invention is 6% or more, preferably 7% or more, and more preferably 7.5% or more. On the other hand, to increase DOL, the content of MgO is 10.5% or less, preferably 9.5% or less, and more preferably 9% or less.

TiO₂ is a component of enhancing DUV resistance. On the other hand, when TiO₂ is too much, DOL decreases. For this reason, the content of TiO₂ is more than 0% and 5% or less. It is preferably 0.01% or more, and more preferably 0.03% or more, and is preferably 3% or less, more preferably 1% or less, still more preferably 0.5% or less, still further preferably 0.4% or less, and particularly preferably 0.3% or less.

ZrO₂ is a component of giving excellent DUV resistance, and at the same time, enhancing chemical durability and increasing CS in chemical strengthening, and additionally improving Vickers hardness after chemical strengthening, and therefore can be contained.

The glass according to the present invention preferably contains TiO₂ and ZrO₂ together, and in the case where ZrO₂ is contained, the content thereof is preferably 0.1% or more, more preferably more than 0.11%, still more preferably 0.12% or more, and still further preferably 0.13% or more.

On the other hand, from the standpoints of suppression of the devitrification when manufacturing a glass and prevention of the decrease of DOL when conducting chemical strengthening, the content of ZrO₂ is preferably 4% or less, more preferably 3% or less, still more preferably 2% or less, still further preferably 1.5% or less, and particularly preferably 1% or less.

The glass for chemical strengthening according to the present invention preferably satisfies the relationship that in the contents of Na₂O, K₂O, Al₂O₃, ZrO₂, and TiO₂ in terms of mol percentage based on oxides, [(Na₂O+K₂O×5)/(Al₂O₃+ZrO₂+TiO₂×10)] is 2.55 or less.

As described above, Na₂O and K₂O are components of increasing DOL, but on the other hand, deteriorating CS and DUV resistance. Furthermore, those are components of decreasing a temperature T2 at which a viscosity of a glass reaches 10² dPa·s and a temperature T4 at which a viscosity of a glass reaches 10⁴ dPa·s.

Al₂O₃, ZrO₂ and TiO₂ are components that can enhance CS and DUV resistance, but on the other hand, decreasing DOL. Furthermore, Al₂O₃ is a component of increasing the temperature T2 and the temperature T4, and therefore when contained too much, a viscosity at high temperature is increased, leading to the deterioration of productivity of a glass.

Specifically, from the balance of CS, DOL, acid resistance, and productivity, the value represented by [(Na₂O+K₂O×5)/(Al₂O₃+ZrO₂+TiO₂×10)] is preferably 2.55 or less, more preferably 2.0 or less, still more preferably 1.9 or less, still further preferably 1.8 or less, still further more preferably 1.75 or less, and particularly preferably 1.71 or less. Furthermore, it is preferably 0.1 or more, more preferably 0.5 or more, and still more preferably 1.0 or more.

In the present invention, particularly to increase CS and to enhance acid resistance, the contents of Al₂O₃ and K₂O in terms of mol percentage based on oxides preferably satisfy the relationship that Al₂O₃/K₂O exceeds 10. The Al₂O₃/K₂O is more preferably 10.3 or more, still more preferably 10.5 or more, still further preferably 11.5 or more, still further more preferably 12.5 or more, particularly preferably 14.0 or more, and most preferably 15.0 or more.

The contents of MgO, Na₂O, K₂O, ZrO₂, and TiO₂ in terms of mol percentage based on oxides preferably satisfy the relationship that [(MgO/2+Na₂O+K₂O×2)/(TiO₂+ZrO₂)] is 53 to 140 from that the amount of sludge during etching described hereinafter can be reduced (hydrofluoric acid resistance can be improved). The value represented by [(MgO/2+Na₂O+K₂O×2)/(TiO₂+ZrO₂)] is more preferably 130 or less, still more preferably 125 or less, and still further preferably 120 or less. Furthermore, it is more preferably 55 or more, and still more preferably 60 or more.

The composition of a glass can be measured with X-ray fluorescence analysis in a simplified manner. According to a wet analysis, the glass composition can be measured further precisely.

Other components that can be contained in the glass of the present invention are described below.

B₂O₃ is a component of accelerating melting of glass raw materials and improving brittleness and weather resistance of a glass.

B₂O₃ may not be contained. When contained, the content thereof may be 1% or more for the reason that a rate of fracture when Vickers indentation has been formed after chemical strengthening can be minimized or meltability at high temperature is enhanced. In order that disadvantages such as formation of ream by volatilization and corrosion of a furnace wall are not generated, the content of B₂O₃ is preferably 15% or less, more preferably 10% or less, still more preferably 7.5% or less, still further more preferably 5% or less, and particularly preferably 3% or less.

P₂O₅ is a component of enhancing scratch resistance without impairing ion exchangeability. P₂O₅ may not be contained. When contained, the content thereof is preferably 1% or more, more preferably 2% or more, and still more preferably 2.5% or more. As a result, a glass having high crack extension initiation load (CIL) can be obtained. The content of P₂O₅ is preferably 10% or less, more preferably 5% or less, and still more preferably 3% or less. As a result, a glass having particularly excellent acid resistance can be obtained.

CaO is a component of stabilizing a glass, and enhances meltability while preventing devitrification by the presence of MgO and suppressing the increase of CTE, and therefore can be contained. The content of CaO is preferably 0 to 5%, more preferably 0 to 3%, and still more preferably 0 to 1%. When the content of CaO is 5% or less, sufficient ion exchange rate is achieved and desired DOL is obtained. In the case of remarkably enhancing ion exchangeability in chemical strengthening, the content of CaO is preferably less than 1%, and more preferably 0.5% or less.

CaO/MgO is preferably 0.5 or less from the standpoint of enhancing ion exchangeability in chemical strengthening and increasing the transmittance of a glass sheet.

Other than the above, SO₃, a chloride, a fluoride, and the like may be appropriately contained as clarifiers of melting of a glass in a range of 0 to 1%.

SrO may be contained as necessary, but deteriorates an ion exchange rate as compared with MgO and CaO. Therefore, SrO is not substantially contained, or when contained, it is preferred that the content thereof is 3% or less.

The term “is not substantially contained” in the present description means that the component is not contained excluding inevitable impurities, and the content thereof is, for example, preferably less than 0.05%, and more preferably less than 0.01%.

Of alkaline earth metal oxides, BaO has the largest effect of decreasing an ion exchange rate. Therefore, BaO is not substantially contained, or when contained, the content thereof is preferably 3% or less, more preferably 1% or less, and still more preferably 0.5% or less.

When SrO or BaO is contained, the total content of those is preferably 3% or less, more preferably 1% or less, still more preferably 0.5% or less, and still further preferably less than 0.3%.

When any one or more of CaO, SrO and BaO is contained, the total content of those three components is preferably 3% or less, and more preferably less than 3%. When the total is 3% or less, the decrease of an ion exchange rate can be avoided. It is more preferably 1% or less, still more preferably 0.5% or less, and still further preferably less than 0.3%.

Li₂O is a component of excessively decreasing a strain point and low temperature viscosity and easily causing stress relaxation, leading to the decrease of a stress value of a compressive stress layer. Therefore, it is preferably not substantially contained.

Li₂O sometimes elutes in a molten salt such as KNO₃ in the chemical strengthening treatment. When the chemical strengthening treatment is conducted by using a molten salt containing Li, surface compressive stress is remarkably deteriorated. Therefore, from this standpoint also, it is preferred that Li₂O is not substantially contained.

SnO₂ is a component of enhancing DUV resistance. SnO₂ may not be contained. When contained, the content thereof is preferably 0.001% or more, more preferably 0.005% or more, still more preferably 0.01% or more, and particularly preferably 0.02% or more. On the other hand, SnO₂ deteriorates solarization resistance. Therefore, it is preferably 1% or less, more preferably 0.7/0 or less, still more preferably 0.5% or less, still further preferably 0.3% or less, and particularly preferably 0.1% or less.

CeO₂ is a component of enhancing DUV resistance, but on the other hand, greatly deteriorates solarization resistance. The content of CeO₂ is preferably less than 0.1%, more preferably less than 0.05%, and still more preferably less than 0.01%. It is most preferred that it is not substantially contained.

As₂O₃ is a component of making DUV resistance more excellent and accelerating clarification of a glass batch, but has high environmental load. For this reason, it is most preferred that As₂O₃ is not substantially contained.

### <Hydrogen Concentration>

The glass according to the present invention is formed by a float process, and has a bottom surface (back surface) contacting a molten metal (tin) when forming and a top surface (main surface) opposing the bottom surface. The content of tin in the bottom surface is larger than the content of tin in the top surface. The present inventors have found that the amount of defects of an edge portion generated by the chamfering of a float glass varies by the difference of a hydrogen concentration between the top surface and the bottom surface.

In the manufacturing of a glass by a float process, a molten glass is continuously fed to the surface of a molten metal stored in a float bath from the upstream side to form a glass ribbon, while a glass ribbon after forming is pulled out at an end at the downstream side of the float bath, and then gradually cooled in an annealing tank (lehr). Thus, a sheet glass is manufactured.

In the manufacturing of a glass by a float process, an apparatus of a type in which flow passage between a glass melting furnace and a float bath is narrow is generally used. In this case, it is necessary to widen the width of a glass in the float bath. Therefore, as compared with the case of using another type of an apparatus described hereinafter, a molten glass having higher temperature is flow cast on the surface of a molten metal, and formed.

A dew point in the float bath is low. Therefore, H₂O diffuses from the surface of a glass, and H₂O diffuses in the atmosphere from the main surface (top surface). Furthermore, H₂O diffuses in a molten metal from the back surface (bottom surface). As a result, in a float glass manufactured by the apparatus of this type, a hydrogen concentration at a surface side is lower than that inside the glass. However, a gradient of the hydrogen concentration in a depth of 1 to 2 μm in a sheet thickness direction from the surface can be controlled by the manufacturing conditions.

The glass according to the present invention has a main surface and a back surface opposing the main surface, in which the content of tin in the back surface is larger than the content of tin in the main surface, and a hydrogen concentration in a depth of 1 to 2 μm in a sheet thickness direction from the surface of the main surface is gradually decreased in a depth direction. Furthermore, it is preferred that the hydrogen concentration in a depth of 1 to 2 μm in a sheet thickness direction from the surface of the back surface is also gradually deceased in a depth direction.

The term “a hydrogen concentration in a depth of 1 to 2 μm in a sheet thickness direction from the surface is gradually decreased in a depth direction” used herein means, for example, that a hydrogen concentration measured by a secondary ion mass spectrometry under the analysis conditions described hereinafter in the Examples is decreased preferably 5 to 80%/μm, and more preferably 20 to 50%/μm, in a depth direction in a depth of 1 to 2 μm in a sheet thickness direction from the surface.

Diffusion coefficient of H₂O is higher as a temperature is high. Therefore, a diffusion amount of H₂O from the top surface of a float glass contacting an atmosphere having a low dew point or a high temperature is larger than that from the bottom surface thereof contacting a molten metal having lower temperature, and a hydrogen concentration in the top surface of the float glass is lower than that in the bottom surface thereof.

On the other hand, in the manufacturing of a glass by a float process, there is a case that an apparatus of a type that a flow passage is not narrowed between a glass melting furnace and a float bath is used. In the case of manufacturing by the apparatus of this type, it is not necessary to widen a glass in the float bath. Therefore, a molten glass having lower temperature, as compared with the apparatus of the type described before, is flow cast on a high temperature molten metal, and formed.

The diffusion coefficient of H₂O is high as a temperature is high. Therefore, the temperature of the bottom surface of a float glass is sometimes higher than that of the top surface thereof. In such a case, the diffusion amount of H₂O from the bottom surface is larger than that from the top surface thereof, and as a result, the hydrogen concentration in the bottom surface of a float glass is lower than that in the top surface thereof.

Therefore, in the glass manufacture by a float process, depending on the manufacturing conditions, the hydrogen concentration in the top surface is lower than that in the bottom surface, or the hydrogen concentration in the bottom surface is lower than that in the top surface, and as a result, the difference is generated in a hydrogen concentration between the main surface and the back surface.

It is more preferred in the glass according to the present invention that the hydrogen concentration in a depth of 1 to 10 μm in a sheet thickness direction from the surface of the main surface is lower than the hydrogen concentration in a depth of 1 to 10 in a sheet thickness direction from the surface of the back surface.

To reduce the amount of defects of an edge portion when chamfering a chemically strengthened glass, it is preferred in the glass according to the present invention that an absolute value of an average hydrogen concentration ratio in a depth of 1 to 2 μm in a sheet thickness direction from the surfaces of the main surface and the back surface is closer to 1. Specifically, for example, the absolute value of an average hydrogen concentration ratio in a depth of 1 to 2 μm in a sheet thickness direction from the surfaces of the main surface and back surface, measured by secondary ion mass spectrometry under the analysis conditions described hereinafter in the Examples is preferably 0.4 to 1.6, and more preferably 0.6 to 1.4.

The hydrogen concentration of the glass according to the present invention can be evaluated by the following H/Si value.

### [Evaluation of Hydrogen Concentration by H/Si Value]

By evaluating the hydrogen concentration by H/Si value, resolution in a depth direction of SIMS (Secondary Ion Mass Spectrometry) profile and precision of repeated measurements are enhanced.

In the present invention, it is difficult to measure the hydrogen concentration itself and the hydrogen concentration ratio itself with good precision. Therefore, the H/Si value that is in proportion to the hydrogen concentration is used as a direct index of the hydrogen concentration, and “a ratio of the H/Si value in the bottom surface to the top surface” that is in proportion to the hydrogen concentration ratio is used as a direct index of the hydrogen concentration ratio.

The ratio of an average H/Si value in the bottom surface to the top surface in a float glass is obtained by, for example, the following procedures (I) and (II) by a secondary ion mass spectrometry (SIMS). The analysis conditions shown below are examples, and they should be appropriately changed by a measuring apparatus, a sample and the like.

(I) Secondary ion mass spectrometry is performed in each of the top surface and bottom surface up to a depth of 10 μm from a surface layer under the following analysis conditions.

### (Analysis Conditions)

Measuring apparatus: Secondary ion mass spectrometer having double focusing mass spectrometer

Primary ion species: Cs⁺

Primary accelerated voltage: 15.0 kV

Primary ion current: 100 nA

Primary ion incident angle (angle from vertical direction of sample face): about 24.0°

Luster size: 90×90 μm²

Detection region: 30 μm diameter

Secondary ion polarity: Minus

Use of electron gun for neutralization: Used

Surface coating: Material Pt, coating thickness about 10 to 20 nm

Example of the secondary ion mass spectrometer having a double focusing mass spectrometer includes IMS-7f manufactured by CAMECA

(II) Regarding the average H/Si value up to a depth of 10 μm of the H/Si profile obtained by secondary ion mass spectrometry in (I), a ratio of the bottom surface to the top surface is calculated.

The glass according to the present invention is that regarding the average H/Si value in a depth of 1 to 2 μm in a sheet thickness direction from the surface, an absolute value of a ratio of the bottom surface to the top surface is preferably 0.4 to 1.6, and more preferably 0.6 to 1.4.

### <Chamfering and Measurement>

Chamfering of a glass and the measurement of an amount of defects of an edge portion generated by the chamfering are conducted by the following procedures. A glass substrate obtained by making a glass into individual pieces is prepared. Outer periphery of the glass substrate is subjected to chamfering two rounds using a grinding stone by an automatic glass polishing machine. A distance between two points is measured by using a microscope, and the number of chippings having a size of 20 μm or more is counted.

### <Meltability and Formability>

In the glass according to the present invention, a temperature becoming an example of the standard when melting a glass, that is, a temperature T2 at which a viscosity of a glass reaches 10² dPa·s, is preferably 1660° C. or lower, more preferably 1650° C. or lower, and still more preferably 1645° C. or lower.

In the glass according to the present invention, a temperature becoming an example of the standard when forming a glass, that is, a temperature T4 at which a viscosity of a glass reaches 10⁴ dPa·s, is preferably 1255° C. or lower, more preferably 1240° C. or lower, still more preferably 1230° C. or lower, and still further preferably 1225° C. or lower.

The temperature T2 and temperature T4 can be measured by using a rotary viscometer.

### <Amount of Sludge>

A glass is sometimes subjected to an etching treatment for the purpose of, for example, adjustment of surface properties of a glass, but when a glass is etched, sludge (residue) is formed. The sludge may affect, for example, a life of an etchant. Therefore, when a glass is etched, it is preferred that the amount of the sludge is small from the standpoint of productivity and the like. Analysis method of the sludge is described below.

An etchant is added to a glass sheet as a sample, followed by stirring, dissolving the glass, and then allowing to stand. Sludge formed is filtered with a filter paper, and washed with water. After drying the sludge, a weight is measured, and sludge weight is calculated. Analysis of the sludge component can be performed by XRD and SEM-EDX.

The amount of sludge varies depending on etching conditions. For example, in the case where a glass sheet as a sample is a glass sheet of 2.5 cm×2.5 cm×0.55 mm, and etching is performed using 50 mL of an etchant containing 7 wt % of HF and 20 wt % of HCl at 25° C. for 3 minutes, the amount of sludge is preferably 0.66 g or less, more preferably 0.65 g or less, and still more preferably 0.64 g or less, per 1 g of the glass.

Components of the sludge vary depending on the glass composition. Examples thereof include Na₂SiF₆, NaMgAlF₆, Na₂MgAlF₇, KNaSiF₆, and KMgAlF₆.

### <DUV Resistance>

In the present description, the term “DUV resistance” means that when a glass is irradiated with UV (DUV) having a wavelength of 100 to 280 nm, specifically when irradiated with a low pressure mercury lamp having main wavelengths of 185 nm and 254 nm, an Xe gas excimer lamp having a main wavelength of 172 nm, an ArF excimer lamp having a main wavelength of 193 nm, a KrF excimer lamp having a main wavelength of 248 nm, or the like, the decrease of a transmittance at a wavelength of 380 to 780 nm is suppressed.

The UV irradiation of the short wavelength side is generally used in UV cleaning treatment, surface modification, UV sterilization treatment, or the like of a substrate.

As the DUV resistance in the glass according to the present invention, when a transmittance in a wavelength region of 380 to 780 nm before UV irradiation of a short wavelength side is T0 and a transmittance in a wavelength region of 380 to 780 nm after irradiation is T1, DUV induced absorption Δ_{α} in each wavelength represented by the following formula is preferably 0.095 or less, more preferably 0.085 or less, and still more preferably 0.08 or less.

Δ_{α}=−ln(T1/T0)

### <Other Properties>

The glass according to the present invention is preferably formed into a glass sheet. In such a case, a thickness (sheet thickness) of the glass sheet is preferably 0.1 to 3 mm, more preferably 0.1 to 2.0 mm, still more preferably 0.1 to 1.5 mm, still further preferably 0.1 to 1.0 mm, and particularly preferably 0.1 to 0.9 mm.

The glass transition temperature (Tg) of the glass according to the present invention is preferably 550° C. or higher, more preferably 580° C. or higher, still more preferably 600° C. or higher, and still further preferably 620° C. or higher, and is preferably 700° C. or lower. When Tg is 550° C. or higher, it is advantageous in the suppression of stress relaxation in the chemical strengthening treatment, the suppression of thermal warp, and the like.

Tg can be adjusted by, for example, adjusting the total amount of SiO₂ and Al₂O₃ and the amounts of an alkali metal oxide and an alkaline earth oxide.

The average coefficient α of thermal expansion of the glass according to the present invention is preferably 65×10⁻⁷ to 110×10⁻⁷/K in a temperature range of 50 to 350° C. It is more preferably 70×10⁻⁷/K or more, still more preferably 80×10⁻⁷/K or more, and still further preferably 85×10⁻⁷/K or more, and is preferably 100×10⁻⁷/K or less, and more preferably 97×10⁻⁷/K or less. The average coefficient α of thermal expansion of 65×10⁻⁷/K or more is advantageous in the matching with coefficients of thermal expansion of metals and other substances. Furthermore, the average coefficient of thermal expansion can be adjusted by adjusting the amounts of an alkali metal oxide and an alkaline earth oxide.

The density at room temperature of the glass according to the present invention is preferably 2.35 to 2.6 g/cm³. It is more preferably 2.38 g/cm³ or more, and still more preferably 2.40 g/cm³ or more, and is more preferably 2.55 g/cm³ or less, and still more preferably 2.50 g/cm³ or less.

The Young's modulus E of the glass according to the present invention is preferably 60 GPa or more. When the Young's modulus E of a glass is 60 GPa or more, crack resistance and fracture strength of a glass is sufficient. It is more preferably 68 GPa or more, and still more preferably 70 GPa or more.

The Poisson ratio σ of the glass according to the present invention is preferably 0.28 or less. When the Poisson ratio σ is 0.28 or less, crack resistance of a glass is sufficient. It is more preferably 0.25 or less.

### <Chemically Strengthened Glass>

The chemically strengthened glass of the present invention is a chemically strengthened glass obtained by chemically strengthening the glass for chemical strengthening as described above. In other words, it is a chemically strengthened glass having a composition of the glass for chemical strengthening of the present invention as a mother composition, and having a compressive stress layer on the surface thereof.

Specifically, the mother composition of a chemically strengthened glass is a composition of a glass before chemical strengthening (glass for chemical strengthening). The part having tensile stress of the chemically strengthened glass (hereinafter also referred to as a tensile stress part) is the part that is not ion-exchanged. The tensile stress part of the chemically strengthened glass has the same composition as the glass for chemical strengthening, and therefore the composition of the tensile stress part can be considered as a mother composition.

From the standpoints that scratches are difficult to be formed on the surface of a chemically strengthened glass and practically sufficient strength is obtained, the surface compressive stress value (CS) is preferably 900 MPa or more, more preferably 920 MPa or more, still more preferably 950 MPa or more, still further preferably 1000 MPa or more, and particularly preferably 1100 MPa or more. On the other hand, a tensile stress value (CT: Center Tension) at the center of a glass is excessively large, and when a glass breaks, there is a possibility that it breaks into pieces. For this reason, CS is preferably 1400 MPa or less, more preferably 1300 MPa or less, and still more preferably 1280 MPa or less.

In the case where scratch is formed on the surface of a chemically strengthened glass, there is a possibility that a depth of the scratch exceeds a depth of the compressive stress layer (DOL) and the chemically strengthened glass is easy to be broken. For this reason, DOL is preferably 30 μm or more, more preferably 31 μm or more, still more preferably 32 μm or more, and still further preferably 34 μm or more. On the other hand, the tensile stress value (CT) at the center of a chemically strengthened glass is excessively large, and when a chemical strengthened glass breaks, there is a possibility that it breaks into pieces. For this reason, DOL is preferably 60 μm or less, and more preferably 50 μm or less.

The values of CS and DOL can be measured by a surface stress meter. CS and DOL of the chemically strengthened glass can be appropriately adjusted by adjusting treatment conditions of the chemical strengthening treatment, a composition of the glass for chemical strengthening, and the like.

### <Method for Manufacturing Glass>

A method for manufacturing the glass for chemical strengthening according to the present invention is not particularly limited, and a method for forming a molten glass is not particularly limited. For example, glass raw materials are appropriately prepared, melted at about 1500 to 1700° C., homogenized by defoaming, stirring or the like, formed into a sheet by a conventional float process, downdraw process (fusion process or the like), press method, or the like, or cast to formed into a block, annealed, and then cut into a desired size. Thus, a glass sheet is manufactured. Polishing is performed as necessary, but the surface of the glass sheet can be treated with a fluorine agent in addition to polishing or in place of polishing. Considering the manufacturing of the glass sheet in a stable manner, a float process or downdraw process is preferable, and particularly considering the manufacturing of a large-sized glass sheet, a float process is preferable.

The glass sheet of the present invention has a size of a display of tablet PC or smart phone, a size of decorative glass in automobiles, and a size of a window glass of buildings or houses. The glass of the present invention is generally cut into a rectangle, but may be cut into other shapes such as circle or a polygon, and includes a glass having been subjected to drilling.

The glass of the present invention is preferably subjected to a chemical strengthening treatment. Before the chemical strengthening treatment, shaping according to uses, for example, mechanical processing such as cutting, end face machining or drilling, is preferably conducted.

The chemical strengthening treatment can be conducted such that a glass manufactured is cut into a desired size to form a glass sheet, the glass sheet is preheated to about 400° C., and in a molten salt, Na on the glass sheet surface is ion-exchanged with K in the molten salt.

After conducting the ion exchange in the molten salt containing a specific salt, an acid treatment and/or an alkali treatment may be conducted to obtain a chemically strengthened glass having higher strength.

Examples of the molten salt for conducting the ion exchange treatment include alkali nitrate salts such as potassium nitrate, potassium sulfate and potassium chloride, alkali sulfate salts, and alkali chloride salts. Those molten salts may be used alone or may be used as a combination of plural species thereof. To adjust the chemical strengthening property, a salt containing sodium may be mixed.

CS of the chemically strengthened glass can be adjusted by adjusting Na concentration in molten potassium nitrate salt used in ion exchange, a strengthening time and a temperature of a molten salt. To obtain higher CS, Na concentration in the molten potassium nitrate salt is decreased.

DOL can be adjusted by adjusting Na concentration in molten potassium nitrate salt used in ion exchange, a strengthening time and a temperature of a molten salt. To obtain higher DOL, a temperature of a molten salt is increased.

The chemically strengthened glass can be cut after the chemical strengthening treatment. As the cutting method, scribing and breaking by a general wheel chip cutter can be applied, and cutting by laser is also possible. To maintain the strength of a glass, chamfering may be subjected to the cut edge after cutting. The chamfering may be mechanical polishing, and can use a method of treating with a liquid medicine such as hydrofluoric acid.

Uses of the glass of the present invention are not particularly limited. The glass chemically strengthened has high mechanical strength, and is therefore suitable for use in the portions in which shock by dropping and the contact with other substances are anticipated.

Specifically, there is a use for the protection of machines or instruments, for example, a cover glass for a display portion of mobile phones (including multi-functional information terminals such as a smart phone), PHS, PDA, tablet type terminals, notebook type personal computers, game machines, portable audio and moving picture players, electronic books, electronic terminals, watches, cameras, GPS, and the like; a cover glass of a monitor for touch panel operation of those instruments; a cover glass of cookers such as a microwave oven and a toaster oven; a top plate of electromagnetic cookers; a cover glass of meters such as a meter or a gauge; and a glass plate for a read part of copying machines or scanners.

Examples of uses include a glass for window of vehicles, ships or aircrafts; a decorative glass in automobiles; a cover glass of household or industrial lighting equipments, signals, guide lights or electric bulletin boards; showcases; and bullet-proof glasses. Examples of the uses further include a cover glass for protection of solar cells, and a glass material for concentrating light to increase power generation efficiency of solar cells.

Examples of the uses further include a glass for various mirror surfaces, a foundation of information storage media such as HDD, and a substrate of information storage media such as CD, DVD and Blu-ray Disc.

Examples of the uses further include water tanks; tableware such as dishes or cups; various cookers such as bottles or cutting boards; shelf plates and walls of cupboards and refrigerators; and building materials such as roofs and partitions.

In addition of those uses, the chemically strengthened glass manufactured after a chemical strengthening treatment is optimum as a glass material for a display incorporated in various image display devices such as liquid crystal, plasma or organic EL.

### Examples

The present invention is specifically described by reference to the following Examples, but the present invention is not construed as being limited thereto. Examples 1 to 5 are Invention Examples, and Example 6 is Comparative Example. The values in parentheses are calculated values, and blanks show “not contained” or “not evaluated”.

Raw materials were prepared so as to be compositions shown in Table 1 in terms of mol percentage based on oxides, and placed on a platinum crucible, followed by placing in a heat resistance electric furnace of 1650° C., melting for 3 hours, homogenizing, and defoaming.

The glass obtained was poured in a mold, maintained at a temperature of 680° C. for 1 hour, and then cooled to room temperature in a rate of 1° C./min. Thus, a glass block was obtained. Then, the glass block was cut and polished, followed by mirror polishing of both surfaces. Thus, a glass having a predetermined size was obtained.

Also, glasses of Examples 3 and 6 were manufactured by a float process.

### <T2 and T4>

The temperature T2 at which a viscosity of a glass reaches 10² dPa·s and the temperature T4 at which a viscosity of a glass reaches 10⁴ dPa·s were measured by using a rotary viscometer.

### <Sludge Amount and Sludge Component>

Sludge amount was measured by conducting etching of a glass. A glass as a sample was a glass sheet of 2.5 cm×2.5 cm×0.55 mm, and the etching was conducted by dipping in 50 mL of an etchant containing 7 wt % of HF and 20 wt % of HCl at 25° C. for 3 minutes. The sludge formed was filtered with 5A filter paper, cleaned with water, and dried. The weight of the sludge was measured. The sludge amount was converted to a value per 1 g of a glass.

Components of the sludge were identified by XRD measurement. The detailed measurement conditions are as follows.

Apparatus: SmartLab manufactured by Rikagaku Corporation, X-ray source: CuKα ray, X-ray output: 45 kV, 200 mA, Optical system: BB, incident parallel slit: Soller slit 5°, incident slit: ⅓°, light-receiving parallel slit: Soller slit 5°, scanning speed: 10°/min, sampling width: 0.02°, measurement range: 20 to 60°, analysis: PDXL (ver. 2.0, 3.0)

T2 and T4 of the glass obtained, the sludge amount and main components of the sludge are shown in Table 1.

As shown in Table 1, the glasses of Examples 1 to 5 were glasses in which the sludge amount in the etching was small, as compared with the glass of Example 6.

### <Chemical Strengthening Property>

Chemical strengthening treatment was conducted by dipping a glass having a thickness of 0.55 mm in molten potassium nitrate salt having a concentration of 100 wt % at a temperature of 425° C. for 6 hours. The values of CS (MPa) and DOL (μm) of the chemically strengthened glass sheet obtained were measured with a surface stress meter (manufactured by Orihara Manufacturing Co., Ltd.). The results are shown in Table 1.

As shown in Table 1, when glasses were chemically strengthened under the same chemical strengthening conditions, the chemically strengthened glasses according to Examples 1 to 5 showed high CS as compared with the chemically strengthened glass according to Example 6.

### <DUV Resistance>

Transmittances before DUV irradiation and after DUV irradiation of each glass were measured. Specifically, each glass was heat-treated at (Tg+50°) C. for 1 hour, annealed to room temperature in a rate of 1° C./min. The glasses polished so as to have equivalent thickness were then horizontally placed on a table, and irradiated with light of a low pressure mercury lamp (PL21-200, manufactured by Sen Lights Co., Ltd., main wavelengths: 185 nm and 254 nm) for 10 minutes from a position of the upper part of 5 cm apart from the glass sheet, and the transmittance at a wavelength of 380 nm was then measured.

Illumination of 254 nm at an arrangement place of the glass sheet in this case was 8 mW/cm² (measurement by an illuminometer UV-M03A and an optical receiver UV-SD25-M10, manufactured by ORC Manufacturing Co., Ltd.). The transmittance was measured by a spectrophotometer (trade name U-4100) manufactured by Hitachi High-Technologies Corporation).

When the transmittance at a wavelength of 380 nm before light irradiation was T0 and the transmittance at a wavelength of 380 nm after light irradiation was T1, DUV induced absorption Δ_{α} represented by the following formula was calculated. Of transmittances in a wavelength of 380 to 780 nm, the transmittance at a wavelength of 380 nm is the lowest both before and after DUV irradiation. Therefore, if the transmittance equal to or more than the desired value is obtained at the wavelength of 380 nm, it can say that the transmittance equal to or more than the desired value is obtained in a wavelength of 380 to 780 nm.

Δ_{α}=−ln(T1/T0)

If the DUV induced absorption Δ_{α} is less than 0.095, it says that DUV resistance is excellent. The results are shown in Table 1.

### <Hydrogen Concentration>

### [Evaluation of Hydrogen Concentration by H/Si Value]

Regarding the glass of the present invention (Invention Product, Example 3) and a conventional glass (Conventional Product, Example 6), glass sheets having a thickness of 0.7 mm produced by a float process were prepared. Secondary ion mass spectrometry was performed on the top surface and the bottom surface (surface at a side having large tin content) of each glass sheet up to a depth of 10 μm in a sheet thickness direction from the surface under the following analysis conditions.

(Analysis Conditions) Measurement apparatus: Secondary ion mass spectrometer having double focusing mass spectrometer (IMS-7f manufactured by CAMECA)

Primary ion species: Cs⁺

Primary accelerated voltage: 15.0 kV

Primary ion current: 100 nA

Primary ion incident angle (angle from vertical direction of a sample face): about 24.0°

Luster size: 90×90 μm²

Detection region: 30 μm diameter

Secondary ion polarity: Minus

Use of electron gun for neutralization: Used

Surface coating: Material Pt, coating thickness about 10 to 20 nm

Average H/Si value, up to a depth of 10 μm in a sheet thickness direction from the surface, of H/Si profile obtained by secondary ion mass spectrometry was obtained.

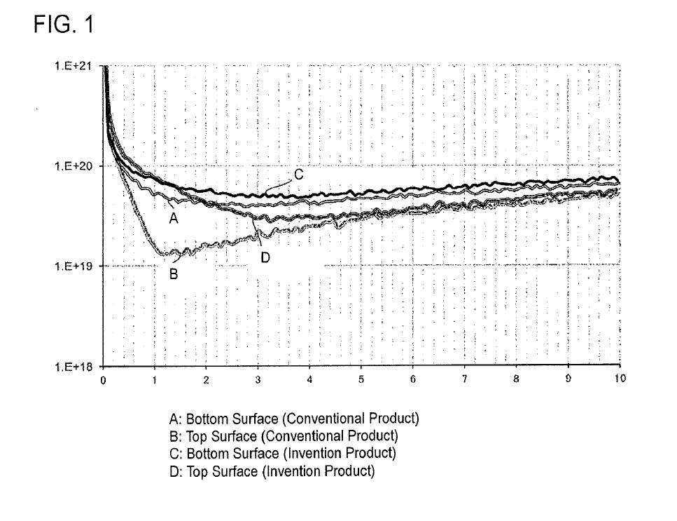

The results are shown in FIG. 1. As shown in FIG. 1, the hydrogen concentrations in the top surface and bottom surface of the glass sheet of the present invention (concentrations calculated from the relationship between H/Si of a sample and H/Si of a reference sample) were gradually decreased in a depth direction in a depth of 1 to 2 μm in a sheet thickness direction from the surface, and the hydrogen concentration was decreased 47%/μm in the top surface and 25%/μm in the bottom surface, in the depth direction. Furthermore, the average hydrogen concentration in a depth of 1 to 10 μm in a sheet thickness direction from the surface of the top surface of the glass sheet of the present invention was lower than the average hydrogen concentration in a depth of 1 to 10 μm in a sheet thickness direction from the surface of the bottom surface.

The hydrogen concentrations in the top surface and bottom surface of the glass sheet of the present invention showed almost parallel decreasing tendency in a depth of 1 to 2 μm in a sheet thickness direction from the surface, and the absolute value of a ratio of the hydrogen concentration in the bottom surface to the top surface was 1.1. On the other hand, the hydrogen concentrations of the top surface and bottom surface of the glass sheet as the Conventional Product did not show parallel decreasing tendency in a depth of 1 to 2 μm in a sheet thickness direction from the surface, the hydrogen concentration did not gradually decrease in the depth direction in the top surface, and the absolute value of a ratio of the bottom surface to the top surface was 3.3. In other words, it was understood that in the glass sheet of the present invention, the difference in hydrogen concentration between the top surface and the bottom surface in the surface part in a depth of 1 to 2 μm was small as compared with the Conventional Product.

### <Chamfering and Measurement>

Glass substrates (Invention Product: Example 3, Conventional Product: Example 6) obtained by making glasses into individual pieces were prepared. The outer periphery of each glass substrate was chamfered two rounds with grindstone manufactured by Noritake Company Limited using an automatic glass grinder. The cut amount in the first round was 0.1 mm in one side, and the cut amount in the second round was 0.05 mm in one side. The distance between two points was measured with magnifications of 200 by using a microscope manufactured by Keyence Corporation, and the number of chippings having a size of 25 μm or more was counted.

A ratio of the number of chippings of the glass as the Invention Product in which the difference in hydrogen concentration in a depth of 1 to 2 μm in a sheet thickness direction from the glass surface between the top surface and the bottom surface is small to the number of chippings of the glass as the Conventional Product in which the difference in hydrogen concentration in a depth of 1 to 2 μm in a sheet thickness direction from the glass surface between the top surface and the bottom surface is large was 0.7.

As a result of verification under a plurality of polishing conditions and chemical strengthening treatment conditions, it was confirmed that when a chemically strengthened glass is obtained by chemically strengthening a glass for chemical strengthening having high compressive stress value (CS value) and small difference in hydrogen concentration in a depth of 1 to 2 μm in a sheet thickness direction from the surface between the top surface and the bottom surface, the ratio can be decreased up to 0.4.

From the above, the present inventors have found that there is a correlation between the difference in hydrogen concentration in the top surface and the bottom surface in the glass for chemical strengthening and the amount of defects in an edge portion in the chamfering of a glass obtained by chemically strengthening the glass for chemical strengthening. Specifically, the amount of defects in an edge portion in the chamfering of the glass for chemical strengthening was reduced as the absolute value of the difference in hydrogen concentration between the top surface and the bottom surface of the glass for chemical strengthening is small.

### <Other Properties>

Glass transition point (Tg) and average coefficient of thermal expansion at 30 to 350° C. of each glass were measured by a thermomechanical analyzer (TMA). The density of each glass was measured by Archimedes' method. Furthermore, Young's modulus of each glass was measured by an ultrasonic pulse method. Those results are shown in Table 1.

TABLE 1

| mol % | Ex. 1 | Ex. 2 | Ex. 3 | Ex. 4 | Ex. 5 | Ex. 6 |
|---|---|---|---|---|---|---|
| SiO₂ | 63.87 | 62.87 | 64.4 | 64.3 | 64.0 | 64.4 |
| Al₂O₃ | 11.38 | 10.93 | 10.5 | 10.48 | 11.0 | 8 |
| MgO | 7.98 | 8.48 | 8.3 | 8.28 | 8.3 | 10.5 |
| CaO | | | | | | 0.1 |
| SrO | | | | | | 0.1 |
| BaO | | | | | | 0.1 |
| Na₂O | 15.47 | 16.37 | 16 | 15.96 | 15.9 | 12.5 |
| K₂O | 0.95 | 1 | 0.6 | 0.8 | 0.6 | 4 |
| ZrO₂ | 0.15 | 0.15 | 0.15 | 0.15 | | 0.5 |
| TiO₂ | 0.2 | 0.2 | 0.05 | 0.05 | 0.2 | |
| [(Na₂O + K₂O × 5)/(Al₂O₃ + | 1.49 | 1.63 | 1.70 | 1.79 | 1.45 | 3.82 |
| ZrO₂ + TiO₂ × 10)] | | | | | | |
| Al₂O₃/K₂O | 12.0 | 10.9 | 17.5 | 13.1 | 18.3 | 2.0 |
| [(MgO/2 + Na₂O + K₂O × 2)/ | 61.0 | 64.6 | 106.8 | 108.5 | 106.3 | 51.5 |
| (TiO₂ + ZrO₂)] | | | | | | |
| T2 (° C.) | 1655 | 1610 | 1640 | 1635 | (1650) | 1600 |
| T4 (° C.) | 1230 | 1195 | 1215 | 1210 | (1220) | 1175 |
| Tg (° C.) | 645 | 628 | 633 | 631 | (640) | 606 |
| Sludge amount (g) | 0.62 | 0.65 | (0.62) | (0.63) | (0.62) | 0.68 |
| Sludge main component | Na₂SiF₆ | Na₂SiF₆ | (Na₂SiF₆) | (Na₂SiF₆) | (Na₂SiF₆) | NaMgAlF₆ |
| CS (MPa) | 1250 | 1230 | 1160 | 1160 | (1240) | 830 |
| DOL (μm) | 36 | 36 | 36 | 37 | (36) | |
| DUV induced absorption Δα | 0.02 | 0.02 | 0.06 | (0.06) | | 0.11 |
| Average coefficient of | 91 | 94 | 91 | 93 | (92) | 98 |
| thermal expansion (×10⁻⁷/K) | | | | | | |
| Specific gravity (g/cm³) | 2.47 | 2.48 | 2.46 | 2.47 | 2.47 | 2.48 |
| Young's modulus (GPa) | 75 | 78 | 73 | 74 | (74) | 74 |
| Poisson ratio | 0.22 | 0.20 | 0.23 | 0.23 | | 0.23 |

As is understood from Table 1, the glasses of Examples 1 to 5 are glasses having small sludge amount in the etching, as compared with the glass of Example 6. Furthermore, the glasses of Examples 1 to 5 have high CS as compared with the glass of Example 6 when the glasses were chemically strengthened under the same chemical strengthening conditions. Furthermore, the glasses of Examples 1 to 5 have low DUV induced absorption Δ_{α} and excellent DUV resistance as compared with the glass of Example 6.

The present invention is described in detail with reference to specific embodiments, but it is apparent for those skilled in the art that various changes or modifications can be made therein without departing from the spirit and the scope of the present invention. This application is based on a Japanese patent application (Application No. 2016-223041) filed on Nov. 16, 2016 and a Japanese patent application (Application No. 2017-190684) filed on Sep. 29, 2017, the whole of which is incorporated herein by reference. In addition, all references cited herein are incorporated as a whole.

1. A glass for chemical strengthening comprising, in terms of mol percentage based on oxides:
SiO₂: 60 to 67%,
Al₂O₃: 9 to 13.5%,
Na₂O: 13.5 to 18.5%,
K₂O: 0.1 to 3%,
MgO: 6 to 10.5%, and
TiO₂: more than 0% and 5% or less,
wherein the glass has a main surface and a back surface opposing the main surface, a tin content in the back surface is larger than a tin content in the main surface, and a hydrogen concentration in a depth of 1 to 2 μm in a sheet thickness direction from a surface of the main surface is gradually decreased in a depth direction.

2. The glass for chemical strengthening according to claim 1, wherein a hydrogen concentration in a depth of 1 to 2 μm in a sheet thickness direction from a surface of the back surface is gradually decreased in a depth direction.

3. The glass for chemical strengthening according to claim 1, wherein a hydrogen concentration in a depth of 1 to 10 μm in a sheet thickness direction from the surface of the main surface is lower than a hydrogen concentration in a depth of 1 to 10 μm in a sheet thickness direction from a surface of the back surface.

4. The glass for chemical strengthening according to claim 1, wherein a temperature T4 at which a viscosity of the glass reaches 10⁴ dPa·s is 1255° C. or lower.

5. The glass for chemical strengthening according to claim 1, further comprising ZrO₂ in an amount of more than 0.11% and 4.0% or less in terms of mol percentage based on oxide.

6. A chemically strengthened glass obtained by chemically strengthening the glass for chemical strengthening according to claim 1.

7. The chemically strengthened glass according to claim 6, having a surface compressive stress (CS) of 900 MPa or more.

8. The chemically strengthened glass according to claim 7, having a depth of a compressive stress layer (DOL) of 30 μm or more.
